(19) United States
(12) Patent Application Publication
(10) Pub. No.: US 2003/0124278 A1
(43) Pub. Date: Jul. 3, 2003

(54) Thermal barriers with solid/solid phase change materials

(76) Inventors: Dustin L. Clark, Boulder, CO (US); Monte C. Magill, Longmont, CO (US); Bernard T. Perry, Erie, CO (US)

Correspondence Address: COOLEY GODWARD, LLP, 3000 EL CAMINO REAL, 5 PALO ALTO SQUARE, PALO ALTO, CA, 94306, US

(21) Appl. No.: 10/037,863

(22) Filed: Jan. 2, 2002

(51) Int. Cl. B29D 22/00; B32B 1/02

(52) U.S. Cl. 428/35.7

(57) ABSTRACT

A thermal barrier comprises a first barrier layer, a second barrier layer, and a temperature regulating material positioned between the first barrier layer and the second barrier layer. The temperature regulating material comprises a solid/solid phase change material in a powdered form, and the first barrier layer is bonded to the second barrier layer to enclose the temperature regulating material within the thermal barrier. The thermal barrier may be used or incorporated in various products or applications where thermal management is desired. For example, the thermal barrier may be used in textiles, apparel, footwear, medical products, containers and packagings, buildings, appliances, and other products.

### FIELD OF THE INVENTION

The present invention relates generally to thermal barriers and methods of manufacturing the same. More particularly, the present invention relates to thermal barriers comprising solid/solid phase change materials and methods of manufacturing the same.

### BACKGROUND OF THE INVENTION

Various types of insulation, such as those used in textiles, apparel, walls and ceilings of buildings, and walls of appliances, typically rely upon reducing heat flow from or to an outside environment so that a desired temperature or range of temperatures may be maintained in an enclosed region. Traditional insulation, such as insulation utilizing fiberglass or dead air space, typically suffers from one or more disadvantages. For instance, the effectiveness of traditional insulation often depends on the amount of insulation material. Accordingly, such insulation may be bulky, inflexible, and/or difficult to install in order to provide adequate insulation capacity and may lose insulation capacity if compressed or when wet. Moreover, traditional insulation may have limited insulation capacity since it works by simply retarding heat flow and generally has a static response and is unable to respond to different conditions of the outside environment and/or the enclosed region.

Attempts at developing superior forms of insulation have led to the use of phase change materials. Rather than simply retarding heat flow, insulation incorporating a phase change material may additionally absorb and/or release thermal energy, usually as the phase change material undergoes a change of phase. Typically, a liquid/solid phase change material (i.e., one that undergoes a transition between liquid and solid phases) is used. While use of a liquid/solid phase change material has overcome certain disadvantages of traditional insulation, it can suffer from certain setbacks, including leakage, volume expansion, and/or flammability concerns associated with the liquid/solid phase change material.

### SUMMARY OF THE INVENTION

In one innovative aspect, the present invention relates to a thermal barrier. In one exemplary embodiment, the thermal barrier may comprise a first barrier layer, a second barrier layer, and a temperature regulating material positioned between the first barrier layer and the second barrier layer. The temperature regulating material may comprise a solid/solid phase change material in a powdered form, and the first barrier layer is bonded to the second barrier layer to enclose the temperature regulating material.

In another exemplary embodiment, the thermal barrier may comprise a first barrier layer, a second barrier layer, and a temperature regulating material positioned between the first barrier layer and the second barrier layer. The temperature regulating material may comprise a base material and a non-encapsulated solid/solid phase change material dispersed within the base material. The first barrier layer is bonded to the second barrier layer to enclose the temperature regulating material.

In another innovative aspect, the present invention relates to a method of forming a thermal barrier. In one exemplary embodiment, the method may comprise: (a) positioning a powdered solid/solid phase change material between a first barrier layer and a second barrier layer; and (b) bonding the first barrier layer to the second barrier layer to enclose the powdered solid/solid phase change material to form the thermal barrier.

In another exemplary embodiment, the method may comprise: (a) incorporating a non-encapsulated solid/solid phase change material in a base material to form a temperature regulating material, wherein the non-encapsulated solid/solid phase change material is dispersed within the base material; (b) positioning the temperature regulating material between a first barrier layer and a second barrier layer; and (c) bonding the first barrier layer to the second barrier layer to enclose the temperature regulating material to form the thermal barrier.

### BRIEF DESCRIPTION OF THE DRAWINGS

For a better understanding of the nature and objects of the invention, reference should be made to the following detailed description taken in conjunction with the accompanying drawings, in which:

FIG. 1 illustrates a thermal barrier in accordance with an embodiment the invention;

FIG. 2 is a cross-sectional view of this embodiment, taken along line 2-2 of FIG. 1;

FIG. 3 illustrates a method of forming a thermal barrier, according to an embodiment of the invention;

FIG. 4 illustrates a thermal barrier in accordance with another embodiment of the invention;

FIG. 5 illustrates a method of forming a thermal barrier, according to another embodiment of the invention;

FIG. 6 illustrates a further embodiment of the invention in which a temperature regulating material comprises two non-encapsulated solid/solid phase change materials;

FIG. 7 illustrates a multi-layered embodiment of a temperature regulating material;

FIG. 8 illustrates a thermal barrier in accordance with a further embodiment of the invention;

FIG. 9 is a cross-sectional view of this embodiment, taken along line 9-9 of FIG. 8;

FIG. 10 illustrates a thermal barrier with a “bubble-wrap” configuration, according with a still further embodiment of the invention; and

FIG. 11 is a cross-sectional view of this embodiment, taken along line 11-11 of FIG. 10.

### DETAILED DESCRIPTION

The present invention relates to thermal barriers comprising solid/solid phase change materials and methods of manufacturing the same. Thermal barriers in accordance with various embodiments of the invention have the ability to absorb and/or release thermal energy to reduce or eliminate heat flow. Such thermal barriers do not suffer from certain disadvantages of traditional insulation, such as, for example, bulkiness and inflexibility. Moreover, the thermal barriers do not suffer from leakage, volume expansion, and/or flammability concerns associated with the use of liquid/solid phase change materials. The thermal barriers may be used or incorporated in various products or applications where thermal management is desired. For example, thermal barriers in accordance with various embodiments of the invention may be used in textiles, apparel (e.g., outdoor clothing, drysuits, helmets, protective pads, and protective suits), footwear (e.g., socks, boots, and insoles), medical products (e.g., thermal blankets, therapeutic pads, incontinent pads, and hot/cold packs), containers and packagings (e.g., beverage or food containers, food warmers, seat cushions, insulation for electronics, insulation for storage, and circuit board laminates), buildings (e.g., insulation in walls or ceilings, wallpaper, curtain linings, pipe wraps, carpets, and tiles), appliances (e.g., insulation in house appliances), and other products (e.g., automotive lining material, insulation for engine compartments, insulation for aircraft and spacecraft, sleeping bags, home furnishings, and bedding).

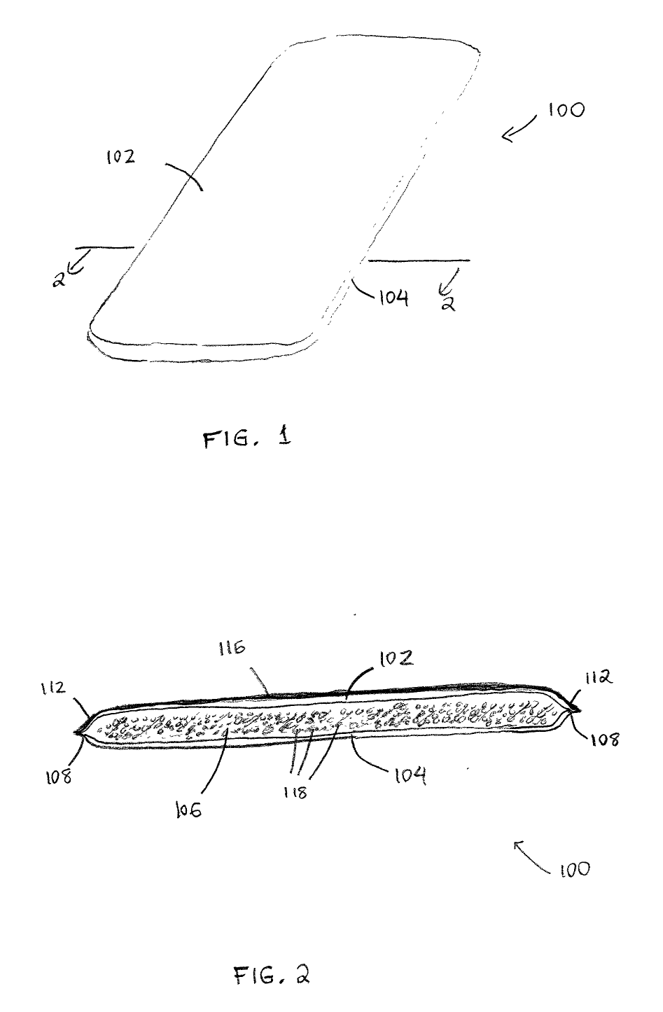

FIG. 1 and FIG. 2 illustrate a thermal barrier 100 in accordance with an embodiment of the invention. The thermal barrier 100 comprises a first barrier layer 102, a second barrier layer 104, and a temperature regulating material 106 positioned between the first barrier layer 102 and the second barrier layer 104. The thermal barrier 100 may be formed into various shapes, such as, for example, a sheet or roll form.

The temperature regulating material 106 comprises a phase change material. In general, a phase change material is any substance (or mixture of substances) that has the capability of absorbing and/or releasing thermal energy to reduce or eliminate heat flow at or within a temperature stabilizing range. The temperature stabilizing range of the phase change material may comprise a particular transition temperature or range of transition temperatures. The phase change material used in accordance with various embodiments of the invention inhibits the flow of thermal energy through the thermal barrier 100 during a time when the phase change material is absorbing or releasing heat, typically as the phase change material undergoes a transition between two phases (e.g., between liquid and solid phases, liquid and gaseous phases, solid and gaseous phases, or two solid phases). This action is typically transient, i.e., until a latent heat of the phase change material is absorbed or released during a heating or cooling process. Thermal energy may be stored or removed from the phase change material, and the phase change material typically can be effectively recharged by a source of heat or cold. By selecting an appropriate phase change material, the thermal barrier 100 may be constructed for use in a particular application where stabilization at a particular temperature stabilizing range is desired.

In the embodiment shown in FIG. 1 and FIG. 2, the temperature regulating material 106 comprises a solid/solid phase change material. Unlike a liquid/solid phase change material, a solid/solid phase change material comprises a type of phase change material that typically does not become liquid during use. A solid/solid phase change material typically undergoes a transition between two solid phases (e.g., a crystalline or mesocrystalline phase transformation). Use of a solid/solid phase change material reduces or eliminates leakage and/or volume expansion problems associated with phase change materials that undergo a transition to a liquid or gaseous phase. In addition, solid/solid phase change materials typically do not suffer from flammability concerns associated with certain liquid/solid phase change materials (e.g., paraffinic hydrocarbons). Finally, solid/solid phase change materials typically do not need to be micro- or macroencapsulated. Accordingly, use of a solid/solid phase change material may reduce expense and loss of solid/solid phase change material associated with a micro- or macroencapsulation process and may enable greater amounts of solid/solid phase change material to be positioned within the thermal barrier 100.

Examples of solid/solid phase change materials suitable for use in the thermal barriers in accordance with various embodiments the invention include, by way of example and not by limitation, polyhydric alcohols, such as 2,2-dimethyl-1,3-propanediol, 2-hydroxymethyl-2-methyl-1,3-propanediol, pentaerythritol, trimethylol ethane (or pentaglycerine), neopentyl glycol, and related compounds. Table 1 lists exemplary solid/solid phase change materials that may be included in the thermal barrier 100.

TABLE 1

2,2-dimethyl-1,3-propanediol
2-hydroxymethyl-2-methyl-1,3-propanediol
2-amino-2-methyl-1,3-propanediol
2-hydroxymethyl-2-nitro-1,3-propanediol
2-amino-2-hydroxymethyl-1,3-propanediol
Pentaerythritol
Monoaminopentaerythritol
Diaminopentaerythritol
Monofluoropentaerythritol
Trimethylol ethane (or pentaglycerine)
Hexachloroethane
Neopentyl glycol
Trimethylol propane
Dimethylpropionic acid
Tris(hydroxymethyl) acetic acid
(CH₃)₂C(CN)—(CH₃)₂C(CN)
(CH₃)₂C(Cl)—(CH₃)₂(Cl)
(CH₃)₂C(CO₂H)—(CH₃)₂(CH₂OH)
Neopentyl alcohol
Neopentane

A solid/solid phase change material may comprise one or more of the exemplary materials listed in Table 1. By selecting two or more different materials and forming a mixture (e.g., a homogeneous blend or an alloy) thereof, a temperature stabilizing range can be adjusted for any particular application of the thermal barrier 100. The temperature stabilizing range may be adjusted over a wide range (e.g., 7° to 200° C.) by selecting various compositions for the mixture.

For example, according to an embodiment of the invention, neopentyl glycol and trimethylol ethane can be melted together to form mixtures with transition temperatures ranging from 20° to 90° C., thus forming solid/solid phase change materials suitable for most situations where a transition temperature is desirably within a moderate temperature range. Table 2 lists exemplary solid/solid phase change materials that may be formed from neopentyl glycol and trimethylol ethane and their associated transition temperatures.

TABLE 2

| Weight Percent Neopentyl | |
|---|---|
| Glycol - Weight Percent | Transition Temperature |
| Trimethylol Ethane | (° C.) |
| 100-0 | 48.9 |
| 90-10 | 38.5 |
| 80-20 | 23.5 |
| 75-25 | 22.1 |
| 70-30 | 26.2 |
| 60-40 | 38.5 |
| 50-50 | 43.6 |
| 40-60 | 47.9 |
| 30-70 | 56.7 |
| 20-80 | 67.1 |
| 10-90 | 74.9 |
| 0-100 | 86.7 |

According to other embodiments of the invention, trimethylol ethane can be combined with pentaerythritol to form mixtures with transition temperatures ranging from 82° to 190° C., and neopentyl glycol can be combined with pentaerythritol to form mixtures with transition temperatures ranging from 39° to 190° C.

According to the embodiment of the thermal barrier 100 shown in FIG. 1 and FIG. 2, the temperature regulating material 106 comprises a non-encapsulated solid/solid phase change material, i.e., the solid/solid phase change material is not micro- or macroencapsulated. For example, the non-encapsulated solid/solid phase change material may comprise the solid/solid phase change material in bulk form, in sheet form, in pellet form, and/or in powdered form. In the embodiment shown in FIG. 2, the solid/solid phase change material is in a powdered form and comprises discrete particles 118. Particles 118 may have a variety of shapes (e.g., spherical, ellipsoidal, or irregularly shaped) and sizes. This powdered form of the solid/solid phase change material provides enhanced flexibility for the thermal barrier 100 and/or provides enhanced surface area that improves insulation capacity of the thermal barrier 100. Typically, the solid/solid phase change material in the powdered form comprises particles 118 with largest linear dimensions (e.g., diameters) of less than about 100 microns.

As shown in FIG. 2, the first barrier layer 102 is bonded to the second barrier layer 104 to enclose or seal the temperature regulating material 106. More particularly, peripheral portion 112 of the first barrier layer 102 is bonded to peripheral portion 108 of the second barrier layer 104 to enclose the temperature regulating material 106.

Certain solid/solid phase change materials may have a tendency to absorb moisture from an outside environment (e.g., air), which can reduce effectiveness of the solid/solid phase change materials over time. Hence, according to some embodiments of the invention, it may be desirable for the first barrier layer 102 and the second barrier layer 104 to further act as a barrier to such moisture and to be bonded to one another so as to enclose the solid/solid phase change material in an airtight seal.

In general, the first barrier layer 102 and the second barrier layer 104 may respectively and independently comprise any substance (or mixture of substances) that provides a barrier to moisture and is sealable to enclose the temperature regulating material 106. A required degree of impermeability to moisture may vary depending on the particular application (e.g., depending on degree of possible exposure to moisture).

In addition to providing barriers to moisture and being sealable, the first barrier layer 102 and/or the second barrier layer 104 may be selected in accordance with one or more additional criteria, such as, for example, flexibility, durability, insulation characteristics, weight, dimension (e.g., width and thickness), and so forth.

Examples of the first barrier layer 102 and the second barrier layer 104 include, by way of example and not by limitation, solid materials (e.g., solid materials in the form of sheets, films, or fabrics) and foamed materials (e.g., foams, both open cell and closed cell). The first barrier layer 102 and/or the second barrier layer 104 may comprise a polymeric material, such as, for example, polyurethane, ethylene/vinyl acetate (EVA) copolymer, latex, polyethylene, polypropylene, butyl, silicone, cellulose acetate, neoprene, epoxy, polystyrene, phenolic, polyvinyl chloride (PVC), polycarbonate, natural rubber, synthetic rubber, and other related polymers. The first barrier layer 102 and the second barrier layer 104 may comprise a same polymeric material or may comprise different polymeric materials. In one embodiment of the invention, the first barrier layer 102 and the second barrier layer 104 comprise flexible, thin, and durable films that provide adequate barriers to moisture and are sealable by a conventional method. In another embodiment of the invention, the first barrier layer 102 and/or the second barrier layer 104 may comprise fibers (e.g., fine, high-density fibers comprising polyethylene) that may be randomly or non-directionally distributed and that are fused or bonded together, such as, for example, by heat and pressure. An example of such a configuration for the first barrier layer 102 and/or the second barrier layer 104 is Tyvek® brand protective material, which is available from DuPont. According to an embodiment of the invention, use of Tyvek® brand protective material may provide advantages such as being lightweight, water-resistant, rip-resistant, and recyclable.

The first barrier layer 102 and/or the second barrier layer 104 may also be thermally reflective. In particular, as shown in FIG. 2, the first barrier layer 102 may comprise a thermally reflective layer 116. In general, the thermally reflective layer 116 may comprise any substance (or mixture of substances) that provides for improved environmental buffering by reflecting and/or retaining thermal energy (e.g., by reducing radiant heat loss or absorption). In the present embodiment, the thermally reflective layer 116 comprises a layer of a metallic substance (e.g., aluminum), which may be formed, for example, as a coating on an outer surface of another layer (e.g., a film) comprising the first barrier layer 102. It should be recognized that the thermally reflective layer 116 may, alternatively or in conjunction, be formed as a coating on an inner surface of another layer comprising the first barrier layer 102 or as an internal layer within the first barrier layer 102. In addition, a substance (or mixture of substances) may be incorporated into the first barrier layer 102 to render it thermally reflective. Also, it should be recognized that the thermal barrier 100 may, alternatively or in conjunction, further comprise a separate thermally reflective layer positioned adjacent and laminated or otherwise bonded to the first barrier layer 102 and/or the second barrier layer 104.

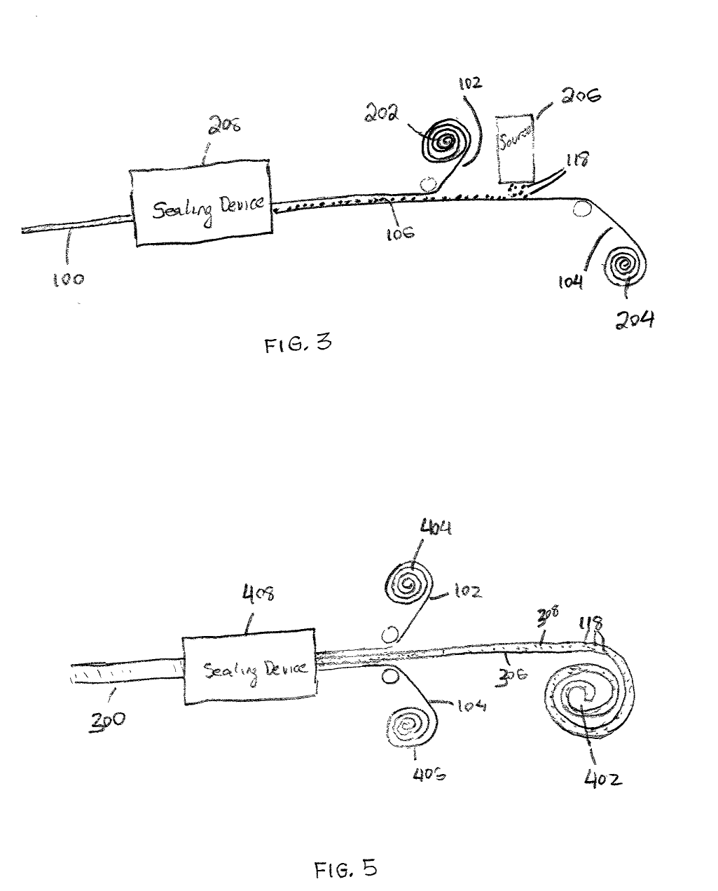

FIG. 3 illustrates a method of forming a thermal barrier (e.g., the thermal barrier 100), according to an embodiment of the invention. The method utilizes a powdered solid/solid phase change material, which may comprise one or more of the exemplary materials listed in Table 1. In particular, the solid/solid phase change material may comprise a mixture of two or more of the exemplary materials (e.g., two different polyhydric alcohols) that are mixed to a desired blend ratio by, for example, melt mixing or forming a saturated solution by dissolving the materials in a solvent (e.g., water) and subsequent removing the solvent. The solid/solid phase change material may then be ground into particles 118, which will typically have diameters less than about 100 microns. As shown in FIG. 3, particles 118 of the solid/solid phase change material are included in a source 206. It should be recognized that particles 118 may be formed from a bulk form within the source 206 or may be formed elsewhere and fed into the source 206.

The powdered solid/solid phase change material is positioned between the first barrier layer 102 and the second barrier layer 104. Specifically, particles 118 of the solid/solid phase change material are dispensed from the source 206 onto the second barrier layer 104 to form the temperature regulating material 106, and the first barrier layer 102 and the second barrier layer 104 are advanced from respective rolls 202 and 204 towards each other to sandwich the temperature regulating material 106. Particles 118 are typically dispensed in measured or controlled quantities to form the temperature regulating material 106 of a desired pattern and/or thickness. For instance, particles 118 may be dispensed uniformly or non-uniformly along the width of the second barrier layer 104 as it is advanced. Furthermore, particles 118 may be dispensed continuously along the length of the second barrier layer 104 as it is advanced or, alternatively, may be dispensed intermittently, such as, for example, in a predetermined timed sequence, as the second barrier layer 104 is advanced. Dispensing particles 118 in a non-uniform and/or an intermittent fashion may be used to form the temperature regulating material 106 having discontinuous patches, which may facilitate bonding of the first barrier layer 102 to the second barrier layer 104 at regions of discontinuity of the temperature regulating material 106.

The first barrier layer 102 is then bonded to the second barrier layer 104 to enclose the powdered solid/solid phase change material to form the thermal barrier 100. In particular, the first barrier layer 102, the second barrier layer 104, and the temperature regulating material 106 are advanced towards a sealing device 208. As discussed previously in connection with FIG. 1 and FIG. 2, the first barrier layer 102 may be bonded to the second barrier layer 104 at their respective peripheral portions 112 and 108. Bonding may be accomplished via any method to enclose the temperature regulating material 106 within the thermal barrier 100 and/or to provide an airtight seal to prevent or reduce exposure of the temperature regulating material 106 to environmental moisture. For example, bonding may comprise heat bonding, radio frequency bonding, and/or adhesive bonding. The resulting thermal barrier 100 may be cut into segments of predetermined lengths or may be collected into a roll.

FIG. 4 illustrates a thermal barrier 300 in accordance with another embodiment of the invention. As with the embodiment shown in FIG. 1 and FIG. 2, the thermal barrier 300 comprises a first barrier layer 102 and a second barrier layer 104. Here, a temperature regulating material 306 is positioned between the first barrier layer 102 and the second barrier layer 104. In the present embodiment, the temperature regulating material 306 comprises a base material 308 and a non-encapsulated solid/solid phase change material dispersed within the base material 308. More particularly, as shown in FIG. 4, the solid/solid phase change material in the present embodiment is in a powdered form and comprises particles 118 dispersed within the base material 308.

In general, the base material 308 may comprise any substance (or mixture of substances) that provides a matrix to facilitate immobilization of the non-encapsulated solid/solid phase change material within the base material 308. This immobilization in turn may prevent or reduce migration of the non-encapsulated solid/solid phase change material inside the thermal barrier 300, such as, for example, when the thermal barrier 300 is used in a non-horizontal orientation. According to some embodiments of the invention, this immobilization is desirable to provide a uniform distribution of solid/solid phase change material so that heat is not preferentially and undesirably conducted across a portion of the thermal barrier 300 that may contain a lesser amount of solid/solid phase change material than another portion. Moreover, this immobilization may prevent or reduce deformation (e.g., sagging) of the thermal barrier 300 as a result of migration of the non-encapsulated solid/solid phase change material. It should be recognized that incorporating the powdered solid/solid phase change material within the base material 308 may also serve to reduce exposure of the powdered solid/solid phase change material to an outside environment and, hence, may reduce contamination and/or exposure to environmental moisture.

In addition to providing a matrix, the base material 308 may be selected in accordance with one or more additional criteria, such as, for example, compatibility (e.g., inertness) with solid/solid phase change material, flexibility, durability, insulation characteristics, weight, dimension (e.g., width and thickness), and so forth.

Examples of the base material 308 include, by way of example and not by limitation, solid materials (e.g., solid materials in the form of sheets, films, pellets, fibers, or fabrics) and foamed materials (e.g., foams, both open cell and closed cell). The base material 308 typically comprises a polymeric material such as, for example, polyurethane, ethylene/vinyl acetate (EVA) copolymer, latex, polyethylene, polypropylene, butyl, silicone, cellulose acetate, neoprene, epoxy, polystyrene, phenolic, polyvinyl chloride (PVC), polycarbonate, natural rubber, and synthetic rubber, and other related polymers.

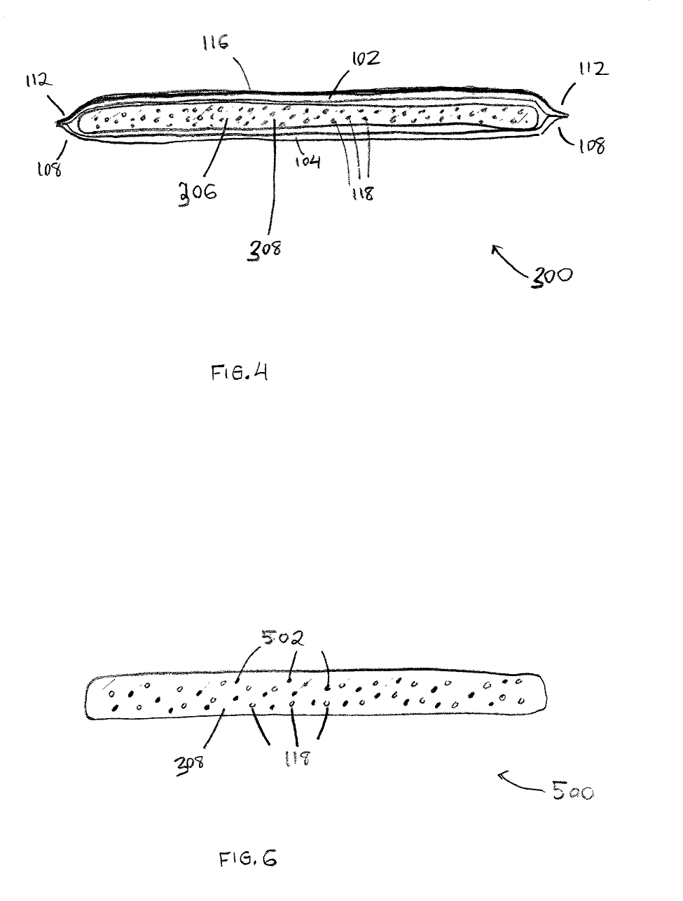

FIG. 5 illustrates a method of forming a thermal barrier (e.g., the thermal barrier 300), according to another embodiment of the invention. First, as with the method shown in FIG. 3, the method of forming the thermal barrier 300 utilizes a non-encapsulated (e.g., powdered) solid/solid phase change material, which may comprise one or more of the exemplary materials listed in Table 1 and may be ground into particles 118, which will typically have diameters less than about 100 microns.

The non-encapsulated solid/solid phase change material is first incorporated in the base material 308, such that the non-encapsulated solid/solid phase change material is dispersed within the base material 308. In particular, particles 118 of the powdered solid/solid phase change material are incorporated in the base material 308 to form the temperature regulating material 306. Typically, the temperature regulating material 306 is formed at temperatures below a melting temperature of the solid/solid phase change material to preserve its powdered form within the temperature regulating material 306. In forming the temperature regulating material 306, particles 118 of the powdered solid/solid phase change material are initially dispersed in a base material mixture, which comprises a pre-solidified form or processing stage of the base material 308 (e.g., liquid or solution form). For example, the base material mixture may comprise a liquid or solution form of one or more polymeric materials, one or more prepolymers, and/or reactants. As one of ordinary skill in the art will understand, the base material mixture may also comprise components such as, for example, surfactants (e.g., to facilitate wetting of particles 118) and dispersing agents (e.g., to facilitate dispersing particles 118 and/or prevent lumping of particles 118). Following dispersal of the particles 118, the base material mixture is solidified and may be shaped or molded to form the base material 308 having the particles 118 dispersed therein. Generally, this may proceed in accordance with conventional methods, which may, for example, include foaming or film formation. According to an embodiment of the invention, the base material 308 comprises a foam that may be formed via a conventional foaming method, such as, for example, by adding a hardening agent which causes a chemical reaction in the base material mixture, thermally setting the base material mixture with heat, or bubbling a gas through the base material mixture while solidifying.

Once formed, the temperature regulating material 306 is positioned between the first barrier layer 102 and the second barrier layer 104. As illustrated in FIG. 5, the temperature regulating material 306 is advanced from roll 402, and the first barrier layer 102 and the second barrier layer 104 are advanced from respective rolls 404 and 406 towards each other to sandwich the temperature regulating material 306. It should be recognized that the first barrier layer 102 and the second barrier layer 104 need not be advanced to overlie and underlie the temperature regulating material 306 at the same time and/or same location along the length of the temperature regulating material 306. For instance, the first barrier layer 102 may be initially positioned to overlie the temperature regulating material 306, and the second barrier layer 104 may be subsequently positioned to underlie the temperature regulating material 306.

The first barrier layer 102 is then bonded to the second barrier layer 104 to enclose the temperature regulating material 306 to form the thermal barrier 300. In particular, the first barrier layer 102, the second barrier layer 104, and the temperature regulating material 306 are advanced towards a sealing device 408. As discussed previously, the first barrier layer 102 may be bonded to the second barrier layer 104 at their respective peripheral portions 112 and 108. As with the method of FIG. 3, bonding may be accomplished via any method to enclose the temperature regulating material 306 within the thermal barrier 300 and/or to provide an airtight seal to prevent or reduce exposure of the temperature regulating material 306 to environmental moisture, such as, for example, via heat bonding, radio frequency bonding, and/or adhesive bonding. The resulting thermal barrier 300 may be cut into segments of predetermined lengths or may be collected into a roll.

With reference to FIG. 4, the solid/solid phase change material in the powdered form may be homogeneously or uniformly dispersed within the base material 308. Alternatively, the solid/solid phase change material in the powdered form may be non-uniformly dispersed within the base material 308, such as, for example, to concentrate particles 118 in one or more regions of the base material 308 or to distribute particles 118 in accordance with a concentration profile along one or more directions along the base material 308. For instance, particles 118 may be dispersed within the base material 308 so as to form various layers with different concentrations of particles 118 within the base material 308. One exemplary method of forming such a configuration comprises laminating or otherwise bonding the various layers of the base material 308 with different concentrations of particles 118 together. Another exemplary method comprises sequentially casting the various layers one on top of another and allowing the various layers to fully solidify when all layers have been cast.

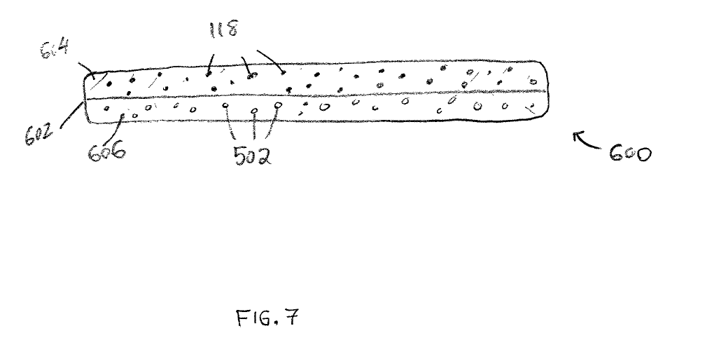

According to a further embodiment of the invention shown in FIG. 6, a temperature regulating material 500 may comprise two or more non-encapsulated solid/solid phase change materials. As with the embodiment shown in FIG. 4, the temperature regulating material 500 comprises the base material 308 and particles 118 of a first solid/solid phase change material dispersed therein. In the present embodiment, particles 502 of a second solid/solid phase change material are also dispersed within the base material 308. The two solid/solid phase change materials may have respective temperature stabilizing ranges that will typically be different. The configuration shown in FIG. 6 may be employed where thermal stabilization is desired at and/or within the two temperature stabilizing ranges. In forming the temperature regulating material 500, the two solid/solid phase change materials may respectively comprise one or more of the exemplary materials listed in Table 1 and may be ground from bulk form into particles 118 and 502, respectively. It should be recognized that the temperature regulating material 500 will typically be positioned and enclosed between two barrier layers (e.g., the two barrier layers 102 and 104), for example, in a manner similar to that shown in FIG. 4.

Rather than distributing particles 118 and 502 uniformly within the base material 308, as, for example, shown in FIG. 6, particles 118 and/or 502 may be non-uniformly distributed, such as, for example, to concentrate particles 118 and 502 in respective regions of the base material 308. FIG. 7 illustrates a multi-layered embodiment of a temperature regulating material 600. Here, particles 118 and 502 are shown dispersed in the base material 602 such as to concentrate particles 118 and 502 in layers 604 and 606, respectively. Exemplary methods of forming the temperature regulating material 600 comprise laminating or otherwise bonding the layers 604 and 606 of the base material 602 together or sequentially casting the layers 604 and 606 and allowing the layers 604 and 606 to fully solidify when both layers 604 and 606 have been cast.

It should be recognized that the temperature regulating material 600 will typically be positioned and enclosed between two barrier layers (e.g., the two barrier layers 102 and 104), for example, in a manner similar to that shown in FIG. 4. Also, the temperature regulating material 600 may, alternatively or in conjunction, comprise a plurality of base materials that are laminated or otherwise bonded together using conventional methods. For instance, a first base material having dispersed therein particles of a first solid/solid phase change material may be bonded to a second base material having dispersed therein particles of a second solid/solid phase change material. The first base material and the second base material will typically be different. For instance, the first base material and the second base material may comprise a polyurethane foam and a polyethylene foam, respectively, or may comprise a polyurethane foam and a polyurethane film, respectively. The first solid/solid phase change material and the second solid/solid phase change material may be the same or different, depending on the particular application. Moreover, one or more of the plurality of base materials need not comprise particles of a solid/solid phase change material.

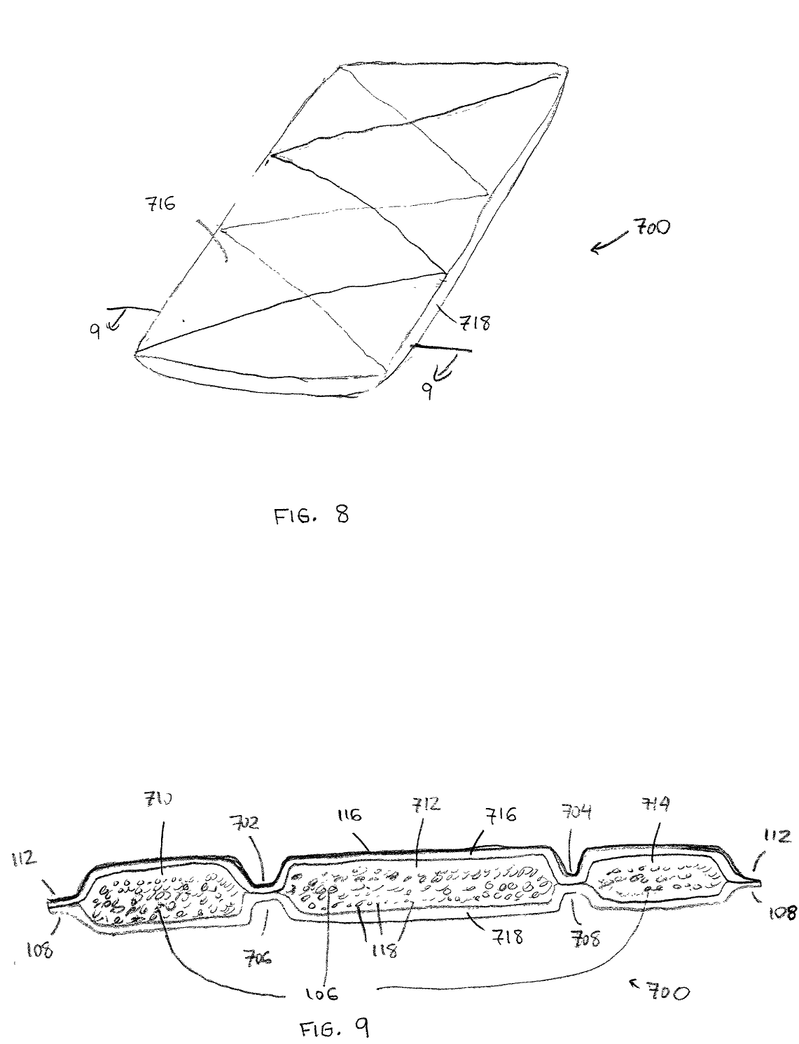

FIG. 8 and FIG. 9 illustrate a thermal barrier 700 in accordance with a further embodiment of the invention. As with the embodiment shown in FIG. 1 and FIG. 2, the thermal barrier 700 comprises a first barrier layer 716, a second barrier layer 718, and the temperature regulating material 106 positioned between the first barrier layer 716 and the second barrier layer 718. As discussed previously, the temperature regulating material 106 comprises particles 118 of a solid/solid phase change material, and peripheral portion 112 of the first barrier layer 716 is bonded to peripheral portion 108 of the second barrier layer 718 to enclose the temperature regulating material 106.

In the present embodiment, interior portions of the first barrier layer 716 are bonded to interior portions of the second barrier layer 718 in a particular sealing pattern. In the embodiment shown in FIG. 8 and FIG. 9, the sealing pattern comprises a criss-cross diamond pattern. This sealing pattern may be used to prevent or reduce migration of the temperature regulating material 106 within the thermal barrier 700. This in turn may provide a uniform distribution of the temperature regulating material 106 and may prevent or reduce deformation (e.g., sagging) of the thermal barrier 700 as a result of migration of the temperature regulating material 106. Furthermore, this sealing pattern may also serve to enhance flexibility of the thermal barrier 700, such as by facilitating bending of the thermal barrier 700 along a portion or portions of the sealing pattern. It should be recognized that various alternate sealing patterns may be used, such as, for example, a rectilinear pattern or a honeycomb pattern.

With reference to FIG. 9, interior portions 702 and 704 of the first barrier layer 716 are bonded to interior portions 706 and 708 of the second barrier layer 718 to define a plurality of compartments 710, 712, and 714. The temperature regulating material 106 is shown positioned within the plurality of compartments 710, 712, and 714. According to the present embodiment, these compartments are non-communicating, such that, for example, particles 118 in compartment 712 are enclosed within the compartment and are prevented from migrating to another compartment or to leak out of the thermal barrier 700.

The thermal barrier 700 may be formed, for example, in a manner similar to that shown in FIG. 3 and comprising an additional step of bonding interior portions of the first barrier layer 716 to interior portions of the second barrier layer 718 in a particular sealing pattern to define a plurality of compartments. Bonding the interior portions may be accomplished using the sealing device 208 and may occur via a similar method used to bond peripheral portions 112 and 108 of the first barrier layer 716 and the second barrier layer 718, such as, for example, via heat bonding, radio frequency bonding, and/or adhesive bonding. As discussed previously, particles 118 may be dispensed from the source 206 in a non-uniform and/or an intermittent fashion to form discontinuous patches of the temperature regulating material 106, which may facilitate bonding of the first barrier layer 716 to the second barrier layer 718 at regions of discontinuity of the temperature regulating material 106. It should be recognized that two or more different solid/solid phase change materials in a powdered form may be positioned within the same or within respective compartments of the thermal barrier 700. For instance, a first phase change material in a powdered form may be positioned within the compartments 710 and 714, and a second phase change material in a powdered form may be positioned within the compartment 712.

Alternatively or in conjunction, the thermal barrier 700 may comprise a temperature regulating material wherein a base material is segmented into a plurality of portions. One or more of these portions of the base material may have a non-encapsulated (e.g., powdered) solid/solid phase change material dispersed therein, and these portions may be positioned within respective compartments of the thermal barrier 700. This configuration may be used to prevent or reduce migration of solid/solid phase change material between compartments and within a particular compartment and/or to enhance insulation capacity of the thermal barrier 700. As an example, a first portion having dispersed therein particles of a first solid/solid phase change material may be positioned within the compartments 710 and 714, and a second portion having dispersed therein particles of a second phase change material may be positioned within the compartment 712. The first solid/solid phase change material and the second solid/solid phase change material may be the same or different, depending on the particular application.

This configuration of the thermal barrier 700 may be formed, for example, in a manner similar to that shown in FIG. 5 and comprising an additional step of bonding interior portions of the first barrier layer 716 to interior portions of the second barrier layer 718 in a particular sealing pattern to define the plurality of compartments. Bonding the interior portions may be accomplished using the sealing device 408 and may occur via a similar method used to bond peripheral portions 112 and 108 of the first barrier layer 716 and the second barrier layer 718, respectively, such as, for example, via heat bonding, radio frequency bonding, and/or adhesive bonding. As part of the bonding process performed by the sealing device 408, the temperature regulating material may be segmented into the plurality of portions, around which the first barrier layer 716 is bonded to the second barrier layer 718. Alternatively, the temperature regulating material may be segmented into the plurality of portions prior to reaching the sealing device 408.

It should be recognized that the temperature regulating material may comprise a plurality of base materials. One or more of the plurality of base materials may have a non-encapsulated (e.g., powdered) solid/solid phase change material dispersed therein, and these base materials may be positioned within respective compartments of the thermal barrier 700. For instance, a first base material having dispersed therein particles of a first solid/solid phase change material may be positioned within the compartments 710 and 714, and a second base material having dispersed therein particles of a second solid/solid phase change material may be positioned within the compartment 712. For instance, the first base material and the second base material may comprise a polyurethane foam and a polyethylene foam, respectively, or may comprise a polyurethane foam and a polyurethane film, respectively. The first solid/solid phase change material and the second solid/solid phase change material may be the same or different, depending on the particular application.

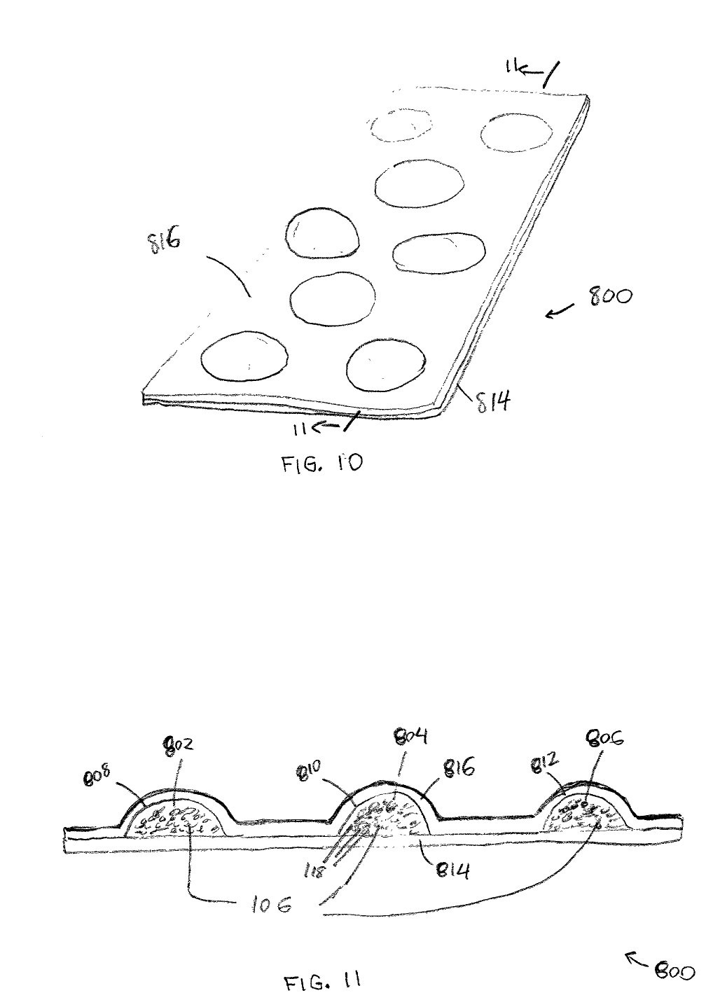

FIG. 10 and FIG. 11 illustrate a thermal barrier 800 with a “bubble-wrap” configuration, according to another embodiment of the invention. This “bubble-wrap” configuration may be used to prevent or reduce migration of the temperature regulating material 106 within the thermal barrier 800. The thermal barrier 800 comprises a first barrier layer 814 and a second barrier layer 816, which may be formed with a plurality of depressions (e.g., depressions 808, 810, and 812). The first barrier layer 814 is bonded to the second barrier layer 816 to define a plurality of compartments (e.g., compartments 802, 804, and 806). The temperature regulating material 106, which comprises particles 118 of a solid/solid phase change material, is positioned between the first barrier layer 814 and the second barrier layer 816 in one or more of the plurality of compartments. Either or both barrier layers 814 and 816 may comprise a thermally reflective layer.

The thermal barrier 800 may be formed, for example, in a manner similar to that described for the thermal barrier 700 and comprising an additional step of forming the plurality of depressions in the second barrier layer 816 in a regular or irregular pattern. The depressions may be formed in a conventional manner. For example, the second barrier layer 816 may be heated till softening, and the second barrier layer 816 may be fed between two pressure forming rollers. One roller may have protrusions extending therefrom, and the other may have cooperating hollows. The temperature regulating material 106 may then be positioned in the formed depressions in the second barrier layer 816, and the first barrier layer 814 is bonded thereto. Bonding may be accomplished using the sealing device 208 and may occur, for example, via heat bonding, radio frequency bonding, and/or adhesive bonding.

It should be recognized that two or more different solid/solid phase change materials in a powdered form may be positioned within the same or within respective compartments of the thermal barrier 800. For instance, a first phase change material in a powdered form may be positioned within the compartments 802 and 806, and a second phase change material in a powdered form may be positioned within the compartment 804. It should be further recognized that the first barrier layer 814 may be formed with a plurality of depressions that match and underlie the plurality of depressions of the second barrier layer 816. In addition, a plurality of segmented portions of a base material or a plurality of base materials, one or more of which have a non-encapsulated (e.g., powdered) solid/solid phase change material dispersed therein, may be positioned within respective compartments of the thermal barrier 800.

Various other embodiments of the thermal barrier may be formed. For instance, with reference to FIG. 1 and FIG. 2, the thermal barrier 100 may further comprise a structure (e.g., a compartment-defining structure) positioned between the two barrier layers 102 and 104 and enclosed within the thermal barrier 100. The compartment-defining structure may be bonded to the two barrier layers 102 and 104 to define a plurality of compartments. The temperature regulating material 106 may be positioned within the plurality of compartments to prevent or reduce migration of the temperature regulating material 106 within the thermal barrier 100. This in turn may provide a uniform distribution of the temperature regulating material 106 and may prevent or reduce deformation (e.g., sagging) of the thermal barrier 100 as a result of migration of the temperature regulating material 106. An example of the compartment-defining structure having a corrugated-type shape comprises an interconnecting sheet bonded at alternating offset interior portions of the first barrier layer 102 and the second barrier layer 104. A further example of the compartment-defining structure comprises a grid having interconnecting walls positioned within the thermal barrier 100 and bonded to interior portions of the two barrier layers 102 and 104. The grid may be formed in various patterns, such as, for example, rectilinear, hexagonal, honeycomb, or other regular or irregular patterns. It should be recognized that two or more different solid/solid phase change materials in a powdered form may be positioned within the same or within respective compartments. It should be further recognized that a plurality of segmented portions of a base material or a plurality of base materials, one or more of which have a non-encapsulated (e.g., powdered) solid/solid phase change material dispersed therein, may be positioned within respective compartments.

As another example, an embodiment of the thermal barrier comprises a compartment-defining structure (e.g., the grid discussed above) positioned between two barrier layers to define a plurality of compartments. In this embodiment, the two barrier layers may be bonded to the compartment-defining structure but need not be bonded to one another. One or more different solid/solid phase change materials in a powdered form may be positioned within the same or within respective compartments. Alternatively or in conjunction, a plurality of segmented portions of a base material or a plurality of base materials, one or more of which have a non-encapsulated (e.g., powdered) solid/solid phase change material dispersed therein, may be positioned within respective compartments.

As a further example, an embodiment of the thermal barrier comprises a non-encapsulated (e.g., powdered) solid/solid phase change material coated onto a base material (e.g., a fabric or pre-solidified foam). Coating may be accomplished via a conventional method, such as, for example, using a polymeric binder or other adhesive. The coated base material may be positioned between two barrier layers, which may be bonded to one another to enclose the coated base material.

As a final example, an embodiment of the thermal barrier may comprise three or more barrier layers stacked one on top of another. Peripheral portions of the various barrier layers may be bonded to define a plurality of compartments. In conjunction, interior portions of the various barrier layers may be bonded to one another in a particular sealing pattern. One or more different solid/solid phase change materials in a powdered form may be positioned within the same or within respective compartments. Alternatively or in conjunction, a plurality of segmented portions of a base material or a plurality of base materials, one or more of which have a non-encapsulated (e.g., powdered) solid/solid phase change material dispersed therein, may be positioned within respective compartments.

### EXAMPLES

The following examples describe specific aspects of the invention to illustrate and provide a description of the invention for those of ordinary skill in the art. The examples should not be construed as limiting the invention, as the examples merely provide specific methodology useful in understanding and practicing the invention.

### Example 1

A solid/solid phase change material is prepared by melt mixing together equal amounts of neopentyl glycol and trimethylol ethane to yield a 50/50 homogeneous blend. The resulting blend is cooled and ground to yield a powder with particles less than 100 microns in diameter. This powder is then positioned onto a first 50 micron thick barrier layer. This barrier layer comprises a high density polyethylene film and a thermally reflective layer, which comprises a coating of a submicron thick layer of deposited aluminum. Another barrier layer comprising a polyethylene film with or without a coating is then positioned over the powder and heat sealed to bond peripheral portions of the two barrier layers and to provide a criss-cross pattern diamond pattern with points at 6 inch intervals across the width of the barrier layers, to form a thermal barrier as shown in FIG. 8.

### Example 2

A solid/solid phase change material is prepared by premixing two or more different polyhydric alcohols to a desired blend ratio and either melt mixing or forming a saturated solution in a solvent followed by removal of the solvent. The resulting blend is ground to yield a powder with particles less than 100 microns in diameter. This powder is mixed into a polyurethane polyol premold foam or film mixture. The isocyanate groups of the polyurethane may bind and react with the hydroxyl groups of the polyhydric alcohols on outer surfaces of the particles. This effectively surrounds the particles and prevents migration or contamination. The foam or film mixture is solidified, and the resulting foam or film having the particles dispersed therein may be used as is or may be positioned and sealed between two barrier film layers as in FIG. 4.

An ordinary artisan should require no additional explanation in developing the thermal barriers and methods described herein but may nevertheless find some helpful guidance in the preparation of these thermal barriers and methods by examining standard reference works in the relevant art. For example, an ordinary artisan may choose to review Payne, et al. U.S. Pat. No. 5,532,039, entitled “Thermal Barriers for Buildings, Appliances and Textiles”, and Benson, et al. U.S. Pat. No. 4,572,864, entitled “Composite Materials for Thermal Energy Storage”, the disclosures of which are hereby incorporated by reference in their entirety.

Each of the patent applications, patents, publications, and other published documents mentioned or referred to in this specification is herein incorporated by reference in its entirety, to the same extent as if each individual patent application, patent, publication, and other published document was specifically and individually indicated to be incorporated by reference.

While the present invention has been described with reference to the specific embodiments thereof, it should be understood by those skilled in the art that various changes may be made and equivalents may be substituted without departing from the true spirit and scope of the invention as defined by the appended claims. In addition, many modifications may be made to adapt a particular situation, material, composition of matter, method, process step or steps, to the objective, spirit and scope of the present invention. All such modifications are intended to be within the scope of the claims appended hereto. In particular, while the methods disclosed herein have been described with reference to particular steps performed in a particular order, it will be understood that these steps may be combined, sub-divided, or re-ordered to form an equivalent method without departing from the teachings of the present invention. Accordingly, unless specifically indicated herein, the order and grouping of the steps is not a limitation of the present invention.

What is claimed is:

1. A thermal barrier comprising:
a first barrier layer;
a second barrier layer; and
a temperature regulating material positioned between the first barrier layer and the second barrier layer, wherein the temperature regulating material comprises a solid/solid phase change material in a powdered form, and wherein the first barrier layer is bonded to the second barrier layer to enclose the temperature regulating material.

2. The thermal barrier of claim 1, wherein the solid/solid phase change material is a polyhydric alcohol or a mixture of polyhydric alcohols.

3. The thermal barrier of claim 1, wherein the barrier layers are flexible films.

4. The thermal barrier of claim 1, wherein the barrier layers comprise a polymeric material independently selected from the group consisting of polyurethane, ethylene/vinyl acetate copolymer, latex, polyethylene, polypropylene, butyl, silicone, cellulose acetate, neoprene, epoxy, polystyrene, phenolic, polyvinyl chloride, polycarbonate, natural rubber, and synthetic rubber.

5. The thermal barrier of claim 1, wherein at least one of the barrier layers is thermally reflective.

6. The thermal barrier of claim 5, wherein said thermally reflective barrier layer comprises a thermally reflective layer or coating.

7. The thermal barrier of claim 1, wherein the first barrier layer is bonded to the second barrier layer to define a plurality of compartments, and wherein the temperature regulating material is positioned within said compartments.

8. The thermal barrier of claim 1, wherein the temperature regulating material further comprises a base material, and wherein the solid/solid phase change material is dispersed within the base material.

9. The thermal barrier of claim 8, wherein the base material is a foam or a film.

10. The thermal barrier of claim 8, wherein the base material comprises a polymeric material selected from the group consisting of polyurethane, ethylene/vinyl acetate copolymer, latex, polyethylene, polypropylene, butyl, silicone, cellulose acetate, neoprene, epoxy, polystyrene, phenolic, polyvinyl chloride, polycarbonate, natural rubber, and synthetic rubber.

11. A thermal barrier comprising:
a first barrier layer;
a second barrier layer; and
a temperature regulating material positioned between the first barrier layer and the second barrier layer, wherein the temperature regulating material comprises a base material and a non-encapsulated solid/solid phase change material dispersed within the base material, and wherein the first barrier layer is bonded to the second barrier layer to enclose the temperature regulating material.

12. The thermal barrier of claim 11, wherein the solid/solid phase change material is in a powdered form.

13. The thermal barrier of claim 12, wherein the solid/solid phase change material in the powdered form comprises particles having diameters less than 100 microns.

14. The thermal barrier of claim 11, wherein the solid/solid phase change material is a polyhydric alcohol or a mixture of polyhydric alcohols.

15. The thermal barrier of claim 11, wherein the barrier layers are films that are impermeable to moisture.

16. The thermal barrier of claim 11, wherein the barrier layers comprise a polymeric material independently selected from the group consisting of polyurethane, ethylene/vinyl acetate copolymer, latex, polyethylene, polypropylene, butyl, silicone, cellulose acetate, neoprene, epoxy, polystyrene, phenolic, polyvinyl chloride, polycarbonate, natural rubber, and synthetic rubber.

17. The thermal barrier of claim 11, wherein at least one of the barrier layers is thermally reflective.

18. The thermal barrier of claim 17, wherein said thermally reflective barrier layer comprises a thermally reflective layer or coating.

19. The thermal barrier of claim 11, wherein the base material is a foam or a film.

20. The thermal barrier of claim 11, wherein the base material comprises a polymeric material selected from the group consisting of polyurethane, ethylene/vinyl acetate copolymer, latex, polyethylene, polypropylene, butyl, silicone, cellulose acetate, neoprene, epoxy, polystyrene, phenolic, polyvinyl chloride, polycarbonate, natural rubber, and synthetic rubber.

21. A method of forming a thermal barrier, comprising:
(a) positioning a powdered solid/solid phase change material between a first barrier layer and a second barrier layer; and
(b) bonding the first barrier layer to the second barrier layer to enclose the powdered solid/solid phase change material to form the thermal barrier.

22. The method of claim 21, wherein the solid/solid phase change material is a polyhydric alcohol or a mixture of polyhydric alcohols.

23. The method of claim 21, wherein the barrier layers are flexible films.

24. The method of claim 21, wherein the barrier layers comprise a polymeric material independently selected from the group consisting of polyurethane, ethylene/vinyl acetate copolymer, latex, polyethylene, polypropylene, butyl, silicone, cellulose acetate, neoprene, epoxy, polystyrene, phenolic, polyvinyl chloride, polycarbonate, natural rubber, and synthetic rubber.

25. The method of claim 21, wherein at least one of the barrier layers is thermally reflective.

26. The method of claim 25, wherein said thermally reflective barrier layer comprises a thermally reflective layer or coating.

27. The method of claim 21, wherein bonding the first barrier layer to the second barrier layer in (b) comprises bonding the first barrier layer to the second barrier layer to define a plurality of compartments, and wherein the solid/solid phase change material is positioned within said compartments.

28. A method of forming a thermal barrier, comprising:
(a) incorporating a non-encapsulated solid/solid phase change material in a base material to form a temperature regulating material, wherein the non-encapsulated solid/solid phase change material is dispersed within the base material;
(b) positioning the temperature regulating material between a first barrier layer and a second barrier layer; and
(c) bonding the first barrier layer to the second barrier layer to enclose the temperature regulating material to form the thermal barrier.

29. The method of claim 28, wherein incorporating the solid/solid phase change material in the base material in (a) comprises:
(i) dispersing the solid/solid phase change material in a base material mixture; and
(ii) solidifying the base material mixture to form the temperature regulating material.

30. The method of claim 28, wherein the solid/solid phase change material is in a powdered form.

31. The method of claim 30, wherein the solid/solid phase change material in the powdered form comprises particles having diameters less than 100 microns.

32. The method of claim 28, wherein the solid/solid phase change material is a polyhydric alcohol or a mixture of polyhydric alcohols.

33. The method of claim 28, wherein the barrier layers are films that are impermeable to moisture.

34. The method of claim 28, wherein the barrier layers comprises a polymeric material independently selected from the group consisting of polyurethane, ethylene/vinyl acetate copolymer, latex, polyethylene, polypropylene, butyl, silicone, cellulose acetate, neoprene, epoxy, polystyrene, phenolic, polyvinyl chloride, polycarbonate, natural rubber, and synthetic rubber.

35. The method of claim 28, wherein at least one of the barrier layers is thermally reflective.

36. The method of claim 35, wherein said thermally reflective barrier layer comprises a thermally reflective layer or coating.

37. The method of claim 28, wherein the base material is a foam or a film.

38. The method of claim 28, wherein the base material comprises a polymeric material selected from the group consisting of polyurethane, ethylene/vinyl acetate copolymer, latex, polyethylene, polypropylene, butyl, silicone, cellulose acetate, neoprene, epoxy, polystyrene, phenolic, polyvinyl chloride, polycarbonate, natural rubber, and synthetic rubber.
